(19) United States
(12) Patent Application Publication
(10) Pub. No.: US 2026/0078615 A1
(43) Pub. Date: Mar. 19, 2026

(54) MOTOR VEHICLE LOCK FOR A LOCKING ELEMENT OF A MOTOR VEHICLE

(71) Applicant: Brose Schließsysteme GmbH & Co. Kommanditgesellschaft, Wuppertal (DE)

(72) Inventors: Ole HÄGER, Wuppertal (DE); Ludger GRAUTE, Essen (DE); Serkan GÜLKAN, Hattingen (DE); Dirk LEVE, Neuss (DE); Jai-Kwon YU, Bedburg (DE); Ralf BÜSCHER, Remscheid (DE); Christian LIPPOLD, Bochum (DE)

(21) Appl. No.: 19/331,521

(22) Filed: Sep. 17, 2025

(30) Foreign Application Priority Data
Sep. 17, 2024 (DE) 102024126769.0

(51) Int. Cl. E05B 81/14; E05B 81/06; E05B 81/16; E05B 81/64

(52) U.S. Cl. CPC E05B 81/14; E05B 81/06; E05B 81/16; E05B 81/64

(57) ABSTRACT

A motor vehicle lock for a locking element of a motor vehicle, wherein the motor vehicle lock has a lock latch and a pawl system that locks the lock latch in a closed state and releases the lock latch in an open state, wherein the motor vehicle lock has a functional element that can be pivoted about a functional element axis and to which an adjustment range between a first end position and a second end position is assigned, wherein the motor vehicle lock has a sensor system for determining continuous position values for the functional element within the adjustment range. It is proposed that the sensor system comprises a magnetically sensitive sensor assembly, a magnet assembly and a control unit, that the magnet assembly is arranged on the functional element and the sensor assembly is otherwise arranged separately from the magnet assembly on the motor vehicle lock.

### CROSS-REFERENCE TO RELATED APPLICATION

This application claims priority pursuant to 35 U.S.C. 119(a) to German Application No. 102024126769.0, filed Sep. 17, 2024, which application is incorporated herein by reference in its entirety.

### FIELD OF THE INVENTION

The present invention relates to a motor vehicle lock for a locking element of a motor vehicle in accordance with the preamble of claim 1.

### BACKGROUND

Motor vehicle locks of the type in question serve to fix a locking element of a motor vehicle. The term “locking element” is to be understood broadly in this case. It includes, for example, a tailgate, a trunk lid, a hood, a side door, a cargo area flap, a windowpane, a lifting roof or the like of a motor vehicle. The following focuses on the area of application of adjusting the tailgate of a motor vehicle.

The known motor vehicle lock (DE 10 2005 030 042 A1), on which the invention is based, relates to a motor vehicle lock in accordance with the preamble of claim 1. This motor vehicle lock is equipped with a number of functional elements whose position can be monitored using sensors. For monitoring a functional element, the use of a sensor system with a rotary encoder is proposed here to ensure more comprehensive monitoring compared to monitoring by means of microswitches. This is achieved by means of the rotary encoder, not only discrete position values for the functional element are generated, but also continuous position values for the functional element. The rotary encoder used here is coupled to the functional element to be monitored by means of a gear assembly.

This is complex to design due to the need for additional components in the gear assembly. Furthermore, the design flexibility of very compact motor vehicle locks is impaired because the gear assembly requires a considerable amount of installation space.

The invention is based on the problem of designing and developing the known motor vehicle lock in such a way that, with comprehensive monitoring of a functional component, the design effort is reduced, and, at the same time, the design freedom is increased.

The above problem is solved by the features of the characterizing part of Claim 1.

The key fundamental consideration is that a sensor system for determining continuous position values for the functional element can be carried out in a contactless manner by using a sensor system that is based on magnetic interaction between a sensor assembly and a magnet assembly in conjunction with an evaluating control unit. The fact is particularly advantageous that the sensor assembly and magnet assembly are arranged separately from each other, meaning they can be positioned independently of each other in the motor vehicle lock. This is based on the consideration that the magnet assembly can easily be positioned or designed on the functional element in such a way that an adjustment of the functional element is accompanied by a measurable change in the magnetic field at the sensor assembly, which can be detected by the sensor assembly and converted into a position value by the control unit. Coaxial arrangement of the sensor assembly and the magnet assembly is no longer necessary. This simplifies the design and reduces the installation space required, which ultimately leads to greater flexibility in the design.

### SUMMARY

The invention relates to a motor vehicle lock for a locking element of a motor vehicle, wherein the motor vehicle lock has a lock latch and a pawl system that locks the lock latch in a closed state and releases the lock latch in an open state, wherein the motor vehicle lock has a functional element that can be pivoted about a functional element axis and to which an adjustment range between a first end position and a second end position is assigned, wherein the motor vehicle lock has a sensor system for determining continuous position values for the functional element within the adjustment range. It is proposed that the sensor system comprises a magnetically sensitive sensor assembly, a magnet assembly and a control unit, that the magnet assembly is arranged on the functional element and the sensor assembly is otherwise arranged separately from the magnet assembly on the motor vehicle lock, and that the control unit derives the continuous position values for the functional element from the sensor signals of the sensor assembly, which are due to the magnetic interaction between the sensor assembly and the magnet assembly.

In particular, it is proposed that the sensor system comprises a magnetically sensitive sensor assembly, a magnet assembly and a control unit, that the magnet assembly is arranged on the functional element, and that the sensor assembly is otherwise arranged separately from the magnet assembly on the motor vehicle lock, and that the control unit derives the continuous position values for the functional element from the sensor signals of the sensor assembly, which are due to the magnetic interaction between the sensor assembly and the magnet assembly. The term “otherwise” means that the sensor assembly is not arranged on the functional element, but on one of the other components of the motor vehicle lock, for example on a housing part or the like.

In accordance with Claim 2, the adjustment of the functional element is accompanied by a change in the magnetic field generated by the magnet assembly on the sensor assembly. This means a change in the magnitude of the magnetic field strength and/or the direction of the magnetic field strength vector. This results in a variety of design options for the sensor assembly depending on the required detection accuracy for the position values to be determined.

Claim 3 makes it clear that numerous advantageous variants are possible for the design of the magnet assembly. The magnet assembly only has to ensure that, with the adjustment of the functional element, a change occurs in the resulting magnetic field at the sensor assembly. The magnet, which is bent in a preferred variant, offers the advantage of an improved spatial arrangement within the motor vehicle lock. The bent shape allows the magnet to be optimally arranged.

By integrating the magnet assembly into the functional element, the overall design of the motor vehicle lock is simplified, and the number of individual components is reduced. This leads to lower manufacturing costs and an increase in compactness (Claim 4).

The use of a sensor that operates according to the Hall effect in accordance with Claim 5 offers the advantage of high robustness against external influences, such as temperature fluctuations or mechanical stress, which further increases the reliability of the sensor system.

The particularly preferred embodiment in accordance with Claim 6 relates to a special design of the sensor, the sensor signals of which represent the magnetic field strength vector in a predetermined sensor plane. As above, this can affect the magnitude and/or direction of the magnetic field strength vector. With such a defined sensor plane, the magnet assembly can be easily designed so that the adjustment of the functional element is accompanied by a corresponding change in the magnetic field strength vector in the sensor plane.

The integration of the sensor assembly and/or the control unit on the electronic circuit board in accordance with Claim 7 enables a further increase in the compactness of the motor vehicle lock since these components do not have to be arranged separately. The alignment of the electronic circuit board in a plane that is parallel to the sensor plane can further increase compactness.

The preferred embodiments in accordance with claim 8 show advantageous variants for the asymmetrical or eccentric design of the magnet assembly and/or the sensor assembly with respect to the functional element axis. This particularly clearly demonstrates the newly gained design freedom in the design of the sensor system with the proposed solution.

The electronic conversion of the sensor signals into the position values is the subject matter of Claim 9. Regardless of the type of conversion, it is particularly advantageous if the control unit enables the conversion rule to be learned. This is true against the backdrop of the above asymmetrical design and arrangement of the magnet assembly and/or the sensor assembly.

The further preferred embodiments in accordance with Claims 10 to 13 relate to the motorized adjustment of the functional element by means of an electric functional element drive. In this regard, the motorized adjustment is based on the determined position values so that different positions to be approached, for example an intermediate position between the two end positions, can be easily realized.

Because the control unit generates continuous position values in the above sense, the position values can be used to control and to regulate the functional element drive (claim 11). This allows for the setting of preferably predetermined speed profiles such as braking, the functional element drive before reaching the position to be approached.

With the continuous determination of the position values, it is also possible to approach the positions to be approached within the scope of a permissible, predetermined inaccuracy. In accordance with Claim 12, it is proposed to this end that a predetermined position range is assigned to each position to be approached. As soon as the functional element reaches this position range, the position to be approached is considered to have been reached by the control unit. This can lead to an optimized approach to a position in terms of speed and noise generation.

Equipping the end positions with end stops, which function as physical barriers and prevent the functional element from pivoting beyond its permissible limit, results in precise and safe positioning of the functional element, also when the functional element is actuated manually by means of the actuating lever. The braking of the functional element provided in one variant, which is based on the determination of the continuous position values, prevents a sudden and uncontrolled impact of the functional element against the end stops. The end stops, which are preferably designed as elastic buffers, can therefore be designed for a lower load and therefore more economically. The noise generation that arises from the decelerated impact of the functional element on the end stop is also significantly reduced.

The further preferred embodiments in accordance with Claims 14 to 22 also relate to a preferred interaction between the functional element and the motor vehicle lock. In this case, the functional element serves to set the lock state. In a particularly preferred embodiment of Claim 14, one of these lock states is the open state of the motor vehicle lock in which the locking element is released, and another of the lock states is the “theft-proof” lock state in which actuation of the actuating lever does not bring about a transfer of the motor vehicle lock into the open state and, in particular, freewheels. Other lock states such as “central locking on/off” or “child safety lock on/off”can be used alternatively or additionally.

In general, the functional element in accordance with Claim 15 is a lever of the motor vehicle lock, which causes the transference of the motor vehicle lock into the open state. This lever can preferably be a lever that has a direct or indirect locking effect on the lock latch. Accordingly, in accordance with Claim 16, it is preferably provided that the functional element drive implements a motorized opening process based on the determined position values.

The further preferred embodiment in accordance with Claim 17 relates to the manual opening process by means of an actuating lever which can be deactivated in accordance with claim 18 as part of the transfer of the motor vehicle lock to the “theft-proof” lock state. The functional element drive is used for this purpose based on the determined position values.

With the also preferred embodiment in accordance with claim 19, the locking lever serves as support for the lock latch via the transmission system. With a suitable design of the transmission system, the support forces required for supporting and therefore the actuating forces required for actuating the locking lever can be reduced considerably.

A particularly efficient possibility for realizing the design of the transmission system is to equip the transmission system with a first knee joint assembly (Claim 20) and with a second knee joint assembly (Claims 21 and 22).

### BRIEF DESCRIPTION OF THE DRAWINGS

In the following, the invention is explained in more detail with reference to a drawing that merely represents exemplary embodiments. In the drawings

FIG. 1 shows a proposed motor vehicle lock in a perspective view a) diagonally from the front and b) diagonally from the rear;

FIG. 2 shows the motor vehicle lock from FIG. 1 in a rear view; and,

FIG. 3 shows the motor vehicle lock in a rear view with a) the functional element located in the intermediate position, b) the first end position and c) the second end position.

### DETAILED DESCRIPTION OF THE INVENTION

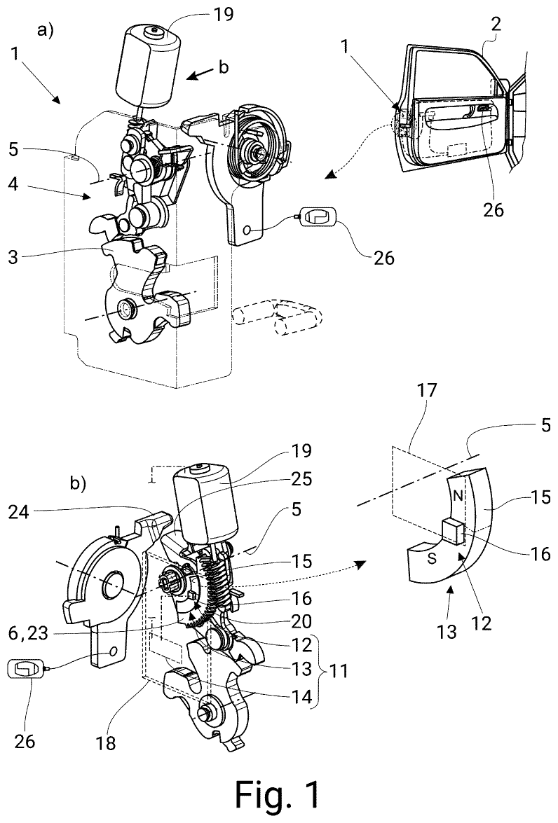

The motor vehicle lock 1 shown in the drawing is assigned in FIG. 1 to a locking element 2 designed as a side door. In principle, an application to all other types of locking elements 2 is conceivable, as was explained in the introductory part of the description.

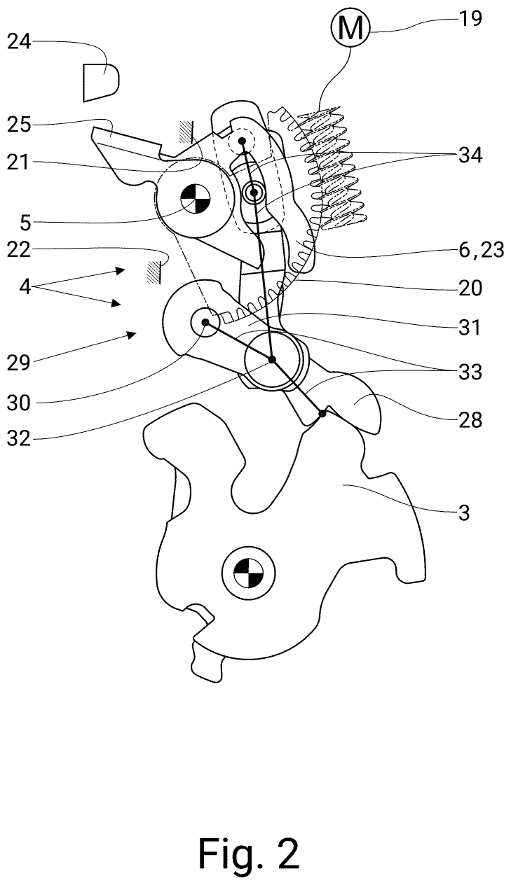

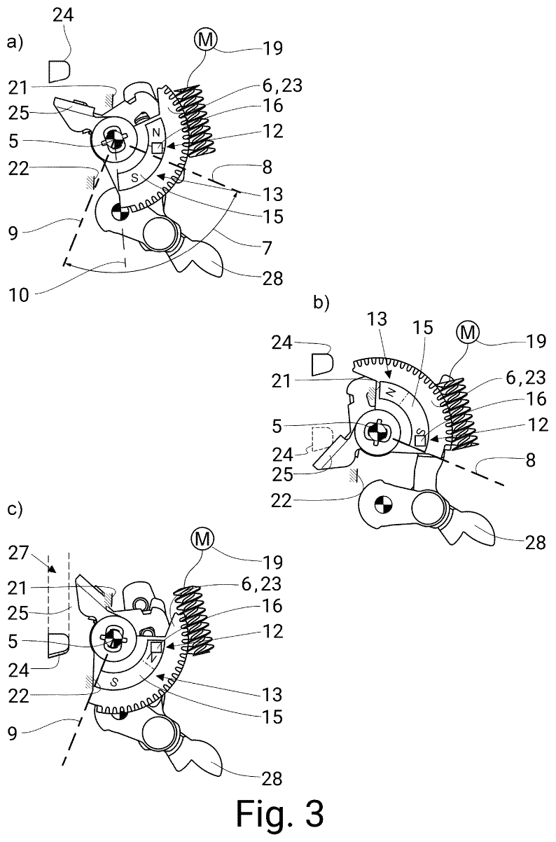

The exemplary embodiment shown in the figures and preferred in this respect relates, as mentioned above, to a motor vehicle lock 1 for a locking element 2 of a motor vehicle, wherein the motor vehicle lock 1 has a lock latch 3 and a pawl system 4 which locks the lock latch 3 in a closed state (FIGS. 2, 3a), 3c)) and releases the lock latch 3 in an open state (FIGS. 1, 3b)). The motor vehicle lock 1 is further equipped with a functional element 6 which can pivot about a functional element axis 5 and which can have very different functions. As will be explained further below, the functional element 6 serves in this case and preferably on the one hand to open the motor vehicle lock 1 and on the other hand to set the “theft-proof”lock state.

The functional element 6 is assigned an adjustment range 7 between a first end position 8 (FIG. 3b)) and a second end position 9 (FIG. 3c)). The first end position 8, the second end position 9 and the intermediate position 10 are shown in FIG. 3 by a dashed auxiliary line that moves tightly with the functional element 6. The adjustment range 7 extends over a pivoting angle which is preferably less than 360°, preferably less than 180° and particularly preferably between 80° and 110°.

To monitor the position of the functional element 6, but also to be able to control the functional element 6 by motor, the motor vehicle lock 1 has a sensor system 11 for determining continuous position values for the functional element 6 within the adjustment range 7.

What is remarkable about the sensor system 11 is the fact that the position values are determined not only for discrete positions of the functional element 6, but continuously over the entire adjustment range 7. As a result, the sensor system 11 has the effect of a resolver which also provides continuous position values. This not only simplifies the sensor system 11 since a plurality of positions can be determined by one and the same sensor system 11 but also increases the control possibilities. This will also be explained below.

What is key is that the sensor system 11 has a magnetically sensitive sensor assembly 12, a magnet assembly 13 and a control unit 14 which determine the above continuous position values for the functional element 6 in a very special way.

The magnet assembly 13 is arranged on the functional element 6, while the sensor assembly 12 is arranged separately from the magnet assembly 13 on the motor vehicle lock 1. The “separate” arrangement means that the sensor assembly 12 on the one hand and the magnet assembly 13 are not mechanically coupled to each other, insofar as this goes beyond the coupling of these two components on the motor vehicle lock 1. Therefore, the sensor assembly 12 on the one hand and the magnet assembly 13 on the other hand can be freely positioned in the motor vehicle lock 1, provided that the sensor function explained below is ensured. This creates a considerable increase in design freedom.

For the above sensor function, it is necessary for there to always be a magnetic interaction between the sensor assembly 12 and the magnet assembly 13. As proposed, the control unit 14 derives the continuous position values for the functional element 6 from the sensor signals of the sensor assembly 12, which are due to the magnetic interaction between the sensor assembly 12 and the magnet assembly 13. The position values for the functional element 6 are therefore determined contactless and continuously over the adjustment range 7.

The term “sensor signal” is to be understood broadly in this context. It includes not only voltage and current signals, but sensor values in particular. These sensor values can already be pre-processed and, for example, already be distance or angle values which are further processed by the control unit 14 to determine the position values.

Furthermore, it is provided in this case and preferably that the sensor assembly 12 and the magnet assembly 13 are designed such that an adjustment of the functional element 6 within the adjustment range 7 leads to a change in the magnetic field generated by the magnet assembly 13 on the sensor assembly 12 and the resulting sensor signals from which the control unit 14 determines the position values for the functional element 6. In comparison of FIGS. 3a), 3b) and 3c), it is easy to imagine that the magnetic field at the sensor assembly 12 changes when the functional element 6 is adjusted, which, if designed accordingly, can lead to a corresponding change in the sensor signals.

Consequently, the design of the magnet assembly 13 in such a way that the position values can be determined from the changing sensor signals by means of the control unit 14 is of particular importance. In this case and preferably, the magnet assembly 13 generally comprises a two-or multi-pole magnet 15. In a preferred embodiment, the magnet 15 has a shape bent around the functional element axis 5. In the illustrated and, in this respect, preferred exemplary embodiment, the magnet 15 is designed in the manner of a bent bar magnet which can be implemented with little effort. Other design variants for the magnet assembly 13 are conceivable depending on the respective boundary conditions.

For the purely constructive design, FIG. 1 shows that the magnet assembly 13 is inserted into the functional element 6. The fastening can be done, for example, by clipping or gluing. In a particularly preferred embodiment, however, the magnet assembly 13 is injected into the functional element 6 using a plastic injection molding process which is particularly advantageous in terms of cost and installation space.

Numerous possibilities are conceivable for the sensor principle of the sensor assembly 12. For example, the sensor assembly 12 can have a sensor 16 that operates according to the MR principle (magnetoresistive principle). In this case and preferably, however, things are such that the sensor assembly 12 has a sensor 16 that operates according to the Hall effect. The sensor 16 preferably generates continuous sensor signals that represent at least one component of a magnetic field strength vector generated by the magnet assembly 13. Preferably, the Hall sensor is designed to determine the magnetic field strength vector in three-dimensional space and to derive corresponding sensor signals therefrom. From this, the continuous position values can in turn be derived with comparatively little effort. Preferably, a Hall sensor from the Melexis® “Triaxis® Pico-Resolver” product series or a comparable sensor 16 is used here.

In this case and preferably, a sensor 16 has been selected to which a sensor plane 17 is assigned, wherein the sensor signals of the sensor 16 represent the magnetic field strength vector generated by the magnet assembly 13 in the sensor plane 17. From these sensor signals, the control unit 14 determines the position values for the functional element 6. Depending on the design boundary condition, the sensor plane 17 can be aligned transversely or parallel to the functional element axis 5. In both preferred cases, it can be expected that the conversion of the sensor signals into the position values is simpler than with any angular position between the sensor plane 17 and the functional element axis 5.

The arrangement of the sensor assembly 12 and the control unit 14 can also contribute to significant compactness. In the exemplary embodiment shown in FIG. 1 and preferred in this respect, the motor vehicle lock 1 is equipped with an electronic circuit board 18 for controlling lock functions, wherein the sensor assembly 12 and/or the control unit 14 is/are arranged on the electronic circuit board 18. In this case and preferably, both the sensor assembly 12 and the control unit 14 are arranged on the electronic circuit board 18.

Since the sensor assembly 12 usually extends along the sensor plane 17, a particularly flat design of the electronic circuit board 18 results, as here, if the electronic circuit board 18 extends in a plane that is aligned parallel to the sensor plane 17.

Preferably, the electronic circuit board 18 is the only circuit board of the motor vehicle lock 1 which also accommodates, for example, all components for the power supply of the functional element drive and any components for an emergency power supply.

Furthermore, it is preferably provided in this case that the magnet assembly 13 is designed or arranged asymmetrically, not point-symmetrically, and/or eccentrically to the functional element axis 5. This is best seen in the illustrations in accordance with FIG. 3. The same applies to the sensor assembly 12, which, as also shown in FIG. 3, is designed or arranged asymmetrically, in particular not point-symmetrically, and/or eccentrically to the functional element axis 5.

It is in this case and preferably the case that neither the sensor assembly 12 nor the magnet assembly 13 are pivotally mounted about a sensor system axis 11 arranged remote from the functional element axis 5. In this case, the design freedom achieved with the proposed solution is particularly evident.

It is obvious that the relationship between the sensor signals and position values is linear depending on the arrangement and design of the magnet assembly 13. In this case and preferably, it is provided that the control unit 14 converts the sensor signals of the sensor assembly 12 into the continuous position values for the functional element 6 by means of a conversion rule. The conversion rule can be a calculation rule. Alternatively, the conversion rule is a tabular rule that maps corresponding discrete sensor signals into discrete position values. “Tabular” in this case is understood to mean in general that an associated sensor value or sensor value set is saved in the control unit 14 for each position value, wherein this relationship then forms the basis for the above conversion. The conversion rule is preferably saved in the control unit 14.

In all the above-mentioned variants of a conversion rule, it is particularly advantageous if the conversion rule can be learned within the context of a learning process, in particular by means of the control unit 14, and can then be saved in the control unit 14. This is particularly noteworthy in view of the above-mentioned freedom in the design and arrangement of the magnet assembly 13 relative to the sensor assembly 12, which can lead to the conversion rule being individually different for each new application.

In the computational conversion rule, learning can be accompanied by a parameterization of an equation. In the case of the tabular conversion rule, this can be filling the table columns. While learning, the sensor signals are preferably compared with the actual position of the functional element 6, which is determined via a separate measuring system.

As will be explained, the functional element 6 in the illustrated and in this respect preferred exemplary embodiment can be adjusted manually and by motor. For the motorized adjustment, it is preferably the case that an electric functional element drive is provided which preferably has an electric, rotary, electric motor 19. The electric motor 19 has a worm gear on its output shaft which meshes with a toothed segment 20 of the functional element 6. The control unit 14 adjusts the functional element 6 by means of the functional element drive and based on the sensor signals of the sensor assembly 12 into a position to be approached, preferably into the first end position 8, into the second end position 9 and into an intermediate position 10 therebetween. By determining the continuous position values for the functional element 6, a motorized adjustment of the functional element 6 into a plurality of positions is possible with only a single sensor system 11.

Furthermore, it is provided in this case and preferably that the control unit 14 controls or regulates the functional element drive based on the determined position values until the position to be approached of the functional element 6 is reached. In so doing, as mentioned above, different speed profiles must be followed. It is particularly preferred that the control unit 14 brakes the functional element drive before reaching the position to be approached. The above braking can be beneficial for noise reduction and wear reduction, as already explained.

The term “braking” is to be understood broadly here. It includes both the reduced driving of the functional element 6 and the active braking, for example by reversing the current of a motor of the functional element drive.

What is also interesting is that not every position to be approached has to be approached exactly. Then, a predetermined position range is assigned to each position to be approached, wherein the control unit 14 evaluates the adjustment of the functional element 6 into the position range as an adjustment of the functional element 6 into the position to be approached. This makes it possible to simplify the control and regulation of the functional element drive and, in many cases, shorten the duration.

Notwithstanding the above motorized approachability of the first end position 8 and the second end position 9 based on the determined position values, a mechanical limitation of the adjustment path of the functional element 6 is additionally provided in this case and preferably. In this regard, it is preferably provided that the motor vehicle lock 1 has a first end stop 21 for the first end position 8 and/or a second end stop 22 for the second end position 9. In the illustrated and in this respect preferred embodiment, both a first end stop 21 as well as a second end stop 22 are realized.

It is interesting in a preferred variant that the control unit 14 brakes the functional element drive before reaching the first end stop 21 and/or the second end stop 22 in such a way that the functional element 6 reaches the first end stop 21 and/or the second end stop 22 in a braked state. This means that the first end stop 21 and the second end stop 22 are reached, but at a reduced speed which reduces the load on the end stops as explained above.

The functional element 6 can assume very different functions and be available in differently designed shape. For example, the functional element 6 can be a drive worm gear of a drive motor, an actuating element with a control contour or, as in this case, a worm wheel with a toothed segment 20. Also, in this case and preferably, the fact is that the functional element 6 also interacts with the motor vehicle lock 1 in such a way that an adjustment of the functional element 6 causes a change in the lock state. The lock state represents the overall state of the motor vehicle lock 1. The lock state can include, for example, the above-mentioned closed state, the open state, the “theft-proof” or “child-proof” state. An adjustment of the functional element 6 into the first end position 8 preferably causes a transfer of the motor vehicle lock 1 into an open state (FIG. 3b)) while an adjustment of the functional element 6 into the second end position 9 causes a transfer of the motor vehicle lock 1 into the “theft-proof” lock state (FIG. 3c)).

In the illustrated and in this respect preferred exemplary embodiment, the fact is that the functional element 6 is a lever, in particular locking lever 23, of the pawl system 4, the opening actuation of which from a locked position (FIG. 3a)) into a release position (FIG. 3b)) causes the release of the lock latch 3 and therefore the transfer of the motor vehicle lock 1 from the closed state to the open state.

Furthermore, it is preferably provided in this case and preferably that the functional element drive is configured to generate the motorized opening actuation, and that the control unit 14 adjusts the functional element 6 for this purpose by controlling the functional element drive based on the sensor signals of the sensor assembly 12 from the intermediate position 10 to the first end position 8, which corresponds to a transition from FIG. 3a) to FIG. 3b). Subsequently, the return from the first end position 8 back to the intermediate position 10 is preferably provided.

It is noteworthy here that the intermediate position 10 is the position in which the functional element 6 blocks the lock latch 3 against adjustment in the opening direction, which corresponds to the closed state. This is explained further below. As a result, the safe approach to the intermediate position 10 is of particular importance for the safe retention of the motor vehicle lock 1 in the closed state. In this case, the determination of the continuous position values can be of particular importance, since an incorrect detection of a position, for example the intermediate position 10, can be largely excluded by checking the position values determined immediately beforehand.

For the manual transfer of the motor vehicle lock 1 into the open state, it is preferably provided that the motor vehicle lock 1 has an actuating lever 24 and the functional element 6 has an engagement part 25, wherein the actuating lever 24 interacts with the engagement part 25 of the functional element 6 to generate a manual opening actuation. For this purpose, the actuating lever 24, which is coupled, for example, to an inside door handle 26, pivots clockwise in FIG. 1b). A manual opening actuation then corresponds to an adjustment of the functional element 6 from the intermediate position 10 to the first end position 8, which corresponds to the transition from FIG. 3a) to FIG. 3b).

It is particularly preferably provided that the sensor signals are used to set at least one of the lock states “theft-proof,” “child-proof” and “two-stroke opening.” A particularly simply designed realization of the “theft-proof” lock state is shown in FIG. 3c). To set the “theft-proof” lock state, the control unit 14 adjusts the functional element 6 by means of the functional element drive based on the sensor signals of the sensor assembly 12 from the intermediate position 10 to the second end position 9, which corresponds to the transition from FIG. 3a) to FIG. 3c). In the second end position 9, the engagement part 25 lies outside the range of movement 27 of the actuating lever 24. The range of movement 27 of the actuating lever 24 is indicated by the dashed line. In this way, the “child-proof” lock state can also be implemented, wherein in particular the actuating lever 24 is assigned to an interior actuation via the inside door handle 26.

In a further embodiment, by adjusting the functional element 6 into the second end position 9, a “two-stroke opening” lock state can be brought about, in which, in a manner known per se, a first actuating stroke of the actuating lever 24 represents an idle stroke relative to the functional element 6, and a subsequent, second actuating stroke then acts on the functional element 6 for a manual opening actuation. The mechanical coupling of the actuating lever 24 and the functional element 6 can be designed for this purpose with a two-stroke mechanism (not shown) which decouples the actuating lever 24 from the functional element 6 with the adjustment of the functional element 6 to the second end position 9 and restores the coupling with the first actuating stroke.

To release the “theft-proof” and/or child-proof” lock state, the control unit 14 adjusts the functional element 6 by means of the functional element drive based on the sensor signals of the sensor assembly 12 from the second end position 9 back to the intermediate position 10, which corresponds to the transition from FIG. 3c) to FIG. 3a).

The illustrated and, in this respect, preferred exemplary embodiment shows a special design of the pawl system 4. In particular, the pawl system 4 is equipped with a pawl 28 which interacts with the lock latch 3 in the closed state of the motor vehicle lock 1 to lock the lock latch 3. This can best be seen in the illustration in accordance with FIG. 2. Furthermore, in this case and preferably, it is the case that the pawl system 4 has a transmission system 29 between the pawl 28 and the locking lever 23 such that the lock latch 3, in the closed state, is supported by the pawl 28 and the transmission system 29 on the locking lever 23 or functional element 6 located in the locked position, which can also be seen from the illustration in accordance with FIG. 2.

Furthermore, in this case and preferably, it is provided that the transmission system 29 has a carrier pawl 31 pivotable about a geometric carrier pawl axis 30, and that the locking pawl 28 is pivotably mounted on the carrier pawl 31 about a geometric locking pawl axis 32 so that the carrier pawl 31 and the locking pawl 28 form a first knee joint assembly 33.

Furthermore, it is provided in this case and preferably that the transmission system 29 has a second knee joint assembly 34 which is coupled to the first knee joint assembly 33, and that the locking lever 23 or the functional element 6 for supporting the lock latch 3 in the closed state interacts with the knee joint of the second knee joint assembly 34 via the first knee joint assembly 33 and the second knee joint assembly 34. The first knee joint assembly 33 and the second knee joint assembly 34 are indicated in FIG. 2 by simple lines of action which, together with the respective pivot axis, form the function of a knee joint.

Finally, it is preferably provided that the transfer of the motor vehicle lock 1 from the closed state to the open state is accompanied by a buckling of both the first knee joint assembly 33 as well as the second knee joint assembly 34, which is a consequence of the above opening actuation. The buckling is shown in FIG. 3b). In order for the above buckling to take place automatically, the arrangement is preferably such that during the transfer of the motor vehicle lock 1 from the closed state to the open state, neither the first knee joint assembly 33 nor the second knee joint assembly 34 passes through the respective dead center.

What is claimed is:

1. A motor vehicle lock for a locking element of a motor vehicle, wherein the motor vehicle lock has a lock latch and a pawl system that locks the lock latch in a closed state and releases the lock latch in an open state, wherein the motor vehicle lock has a functional element that can be pivoted about a functional element axis and to which an adjustment range between a first end position and a second end position is assigned, wherein the motor vehicle lock has a sensor system for determining continuous position values for the functional element within the adjustment range, wherein the sensor system comprises a magnetically sensitive sensor assembly, a magnet assembly and a control unit, in that the magnet assembly is arranged on the functional element and the sensor assembly is otherwise arranged separately from the magnet assembly on the motor vehicle lock, and in that the control unit derives the continuous position values for the functional element from the sensor signals of the sensor assembly, which are due to the magnetic interaction between the sensor assembly and the magnet assembly.

2. The motor vehicle lock according to claim 1, wherein the sensor assembly and the magnet assembly are designed such that an adjustment of the functional element within the adjustment range leads to a change in the magnetic field generated by the magnet assembly on the sensor assembly and the resulting sensor signals, from which the control unit determines the position values for the functional element.

3. The motor vehicle lock according to claim 1, wherein the magnet assembly has a two or multi-pole magnet, preferably in that the magnet has a shape bent around the functional element axis, further preferably in that the magnet is designed in the manner of a bent bar magnet.

4. The motor vehicle lock according to claim 1, wherein the magnet assembly is inserted into the functional element, and/or in that the magnet assembly is injected into the functional element in a plastic injection molding process.

5. The motor vehicle lock according to claim 1, wherein the sensor assembly has a sensor which operates according to the Hall effect, preferably in that the sensor generates continuous sensor signals which represent at least one component of a magnetic field strength vector generated by the magnet assembly.

6. The motor vehicle lock according to claim 1, wherein the sensor is assigned a sensor plane, and in that the sensor signals of the sensor represent the magnetic field strength vector generated by the magnet assembly in the sensor plane, from which the control unit determines the position values for the functional element, preferably in that the sensor plane is aligned transversely or parallel to the functional element axis.

7. The motor vehicle lock according to claim 1, wherein the motor vehicle lock has an electronic circuit board for controlling lock functions, and in that the sensor assembly and/or the control unit is/are arranged on the electronic circuit board, preferably in that the electronic circuit board extends in a plane that is aligned parallel to the sensor plane.

8. The motor vehicle lock according to claim 1, wherein the magnet assembly is designed or arranged asymmetrically, in particular not point-symmetrically, and/or eccentrically to the functional element axis, and/or in that the sensor assembly is designed or arranged asymmetrically, in particular not point-symmetrically, and/or eccentrically to the functional element axis, and/or in that neither the sensor assembly nor the magnet assembly are pivotally mounted about a sensor system axis arranged remote from the functional element axis.

9. The motor vehicle lock according to claim 1, wherein the control unit converts the sensor signals of the sensor assembly into the continuous position values for the functional element by means of a conversion rule, preferably in that the conversion rule is a computational rule, or in that the conversion rule is a tabular rule which maps mutually corresponding discrete sensor signals into discrete position values, further preferably in that the conversion rule can be learned in the context of a learning process.

10. The motor vehicle lock according to claim 1, wherein an electric functional element drive is provided for adjusting the functional element, and in that the control unit adjusts the functional element by means of the functional element drive and based on the sensor signals of the sensor assembly into a position to be approached, preferably into the first end position, into the second end position and into an intermediate position therebetween.

11. The motor vehicle lock according to claim 1, wherein the control unit controls or regulates the functional element drive based on the determined position values until the position to be approached of the functional element is reached, preferably in that the control unit brakes the functional element drive before the position to be approached is reached.

12. The motor vehicle lock according to claim 1, wherein a predetermined position range is assigned to each position to be approached, and in that the control unit evaluates the adjustment of the functional element into the position range as an adjustment of the functional element into the position to be approached.

13. The motor vehicle lock according to claim 1, wherein the motor vehicle lock has a first end stop for the first end position and/or a second end stop for the second end position, preferably in that the control unit brakes the functional element drive before reaching the first end stop and/or the second end stop in such a way that the functional element reaches the first end stop and/or the second end stop in a braked state.

14. The motor vehicle lock according to claim 1, wherein the functional element also interacts with the motor vehicle lock in such a way that an adjustment of the functional element causes a change in the lock state, preferably that an adjustment of the functional element into the first end position causes a transfer of the motor vehicle lock into an open state, and that an adjustment of the functional element into the second end position causes a transfer of the motor vehicle lock into the “theft-proof” lock state.

15. The motor vehicle lock according to claim 1, wherein the functional element is a lever, in particular locking lever, of the pawl system, the opening actuation of which from a locked position into a release position causes the release of the lock latch and therefore the transfer of the motor vehicle lock from the closed state to the open state.

16. The motor vehicle lock according to claim 1, wherein the functional element drive is configured to generate the motorized opening actuation, and in that the control adjusts the functional element for this purpose by controlling the functional element drive based on the sensor signals of the sensor assembly from the intermediate position to the first end position and, preferably, then adjusts it from the first end position back to the intermediate position.

17. The motor vehicle lock according to claim 1, wherein the motor vehicle lock has an actuating lever and the functional element has an engagement part and in that, to generate a manual opening actuation, the actuating lever interacts with the engagement part of the functional element, preferably in that the manual opening actuation is accompanied by an adjustment of the functional element into the first end position.

18. The motor vehicle lock according to claim 1, wherein, to set at least one of the lock states “theft-proof,” “child-proof,” and “two-stroke opening,” the control unit adjusts the functional element by means of the functional element drive based on the sensor signals of the sensor assembly from the intermediate position to the second end position, preferably, in the second end position, the engagement part lies outside the range of movement of the actuating lever, more preferably, to release the “theft-proof” and/or “child-proof” lock state, the control unit adjusts the functional element by means of the functional element drive based on the sensor signals of the sensor assembly from the second end position back to the intermediate position.

19. The motor vehicle lock according to claim 1, wherein the pawl system has a pawl, and in that the pawl interacts with the lock latch in the closed state of the motor vehicle lock to lock the lock latch, preferably in that the pawl system has a transmission system between the pawl and the locking lever such that the lock latch, in the closed state, is supported by the pawl and the transmission system on the locking lever or functional element located in the locked position.

20. The motor vehicle lock according to claim 1, wherein the transmission system has a carrier pawl pivotable about a geometric carrier pawl axis, and in that the locking pawl is pivotably mounted on the carrier pawl about a geometric locking pawl axis so that the carrier pawl and the locking pawl form a first knee joint assembly.

21. The motor vehicle lock according to claim 1, wherein the transmission system has a second knee joint assembly which is coupled to the first knee joint assembly and in that the locking lever or the functional element for supporting the lock latch in the closed state interacts with the knee joint of the second knee joint assembly via the first knee joint assembly and the second knee joint assembly.

22. The motor vehicle lock according to claim 1, wherein the transfer of the motor vehicle lock from the closed state to the open state is accompanied by a buckling of both the first knee joint assembly as well as the second knee joint assembly, preferably in that during the transfer of the motor vehicle lock from the closed state to the open state, neither the first knee joint assembly nor the second knee joint assembly pass through the respective dead center.
